(19) United States
(12) Patent Application Publication
(10) Pub. No.: US 2006/0008292 A1
(43) Pub. Date: Jan. 12, 2006

(54) Image forming apparatus

(75) Inventor: Toshihiko Watanabe, Osaka-shi (JP)

Correspondence Address: CASELLA & HESPOS, 274 MADISON AVENUE, NEW YORK, NY, 10016, US

(73) Assignee: Kyocera Mita Corporation, Osaka-shi (JP)

(21) Appl. No.: 11/151,507

(22) Filed: Jun. 13, 2005

(30) Foreign Application Priority Data
Jul. 6, 2004 (JP) 2004-199031

(51) Int. Cl. G03G 15/00

(52) U.S. Cl. 399/107

(57) ABSTRACT

In an image forming apparatus constructed in such a manner that an image is printed on a recording sheet fed from a sheet storage section by a printing section, and the recording sheet carrying the printed image is discharged onto a sheet discharge tray, a sheet stacking surface of the sheet discharge tray has a darker color than a color of an outer surface of an outer casing of the image forming apparatus in the periphery of the sheet discharge tray.

### BACKGROUND OF THE INVENTION

1. Field of the Invention

The present invention relates to an image forming apparatus such as a copier, a facsimile machine, and a printer.

2. Description of the Related Art

Generally, image forming apparatuses such as copiers, facsimile machines, printers, and complex machines thereof are constructed in such a manner that image data read by a scanner is printed on a sheet-like recording medium (hereinafter, called as “a recording sheet”) such as a copy sheet or an overhead projector (OHP) film, or information transmitted from another image forming apparatus, a personal computer, an information terminal apparatus or a like apparatus is printed on a recording sheet, and the printed recording sheet is discharged onto a discharge tray. As disclosed in Japanese Unexamined Patent Publication No. 2003-107816 and Japanese Unexamined Patent Publication No. 2002-307778, for instance, the discharge tray on which a printed recording sheet is discharged is disposed on an upper part of an outer casing or an outer panel of the image forming apparatus, so that a user can easily confirm the existence of the recording sheet or easily pick up the recording sheet.

In recent years, a printer, which is an image forming apparatuses and is widely used in offices, accommodates recording sheets of about one hundred to five hundred in a sheet cassette section within the printer, and discharges a recording sheet bearing a printed image onto an uppermost-located sheet discharge tray defined by an outer casing. Generally, the printer is installed on a desk or near the desk in an office. In view of this, the outer casing of the printer has a bright color, e.g., a color of light gray near white, or a color having a brightness of about N8 in brightness scale, considering harmonization with the color of the outer surface of the desk or the colors of the various office equipment in the office. The color of the outer casing of the printer is near the color of recording sheets or documents.

However, recently, common use of the printer among a group of users is increased by connecting the printer with individual personal computers of the users via a network, as well as dedicated use by a specific user by arranging the printer near the personal computer of the user and connecting the printer with the personal computer. In case that the printer is commonly used by a group of users, there is a case that a user of the group may use the printer remotely located away, depending on the layout of the office. If the color of the outer casing of the printer is too bright, a difference in brightness between the color of the outer casing of the printer and the color of the recording sheet is decreased. Thereby, the user located away from the printer may find difficulty in discriminating the recording sheet from the surface of the outer casing of the printer, even if the recording sheet after the printing has been discharged onto the sheet discharge tray, and accordingly find it difficult to judge whether the recording sheet has been discharged onto the sheet discharge tray.

Particularly, if the user having a poor eyesight is seated away from the printer, and works in a condition that the driving sound of the printer is hardly noticeable, the user may fail to timely pick up the printed recording sheet, if the recording sheet discharged onto the sheet discharge tray is not distinguishable from the sheet discharge tray or the outer casing of the printer. Such a situation is likely to remarkably lower the workability of the user.

It is possible to color the entirety of the outer surface of the outer casing with a dark color, considering a brightness difference between the color of the outer casing including the sheet discharge tray, and the color of the recording sheet, so that the user can easily recognize that the recording sheet has been discharged onto the sheet discharge tray. However, if the entirety of the outer surface of the outer casing has such a dark color, the users may feel the printer having the dark-colored outer casing dark as a whole. If the printer having the dark-colored outer casing is installed in an office in a bright place or on a desk of a bright color, the users may feel incongruity about the printer and the other office equipment surrounding the printer.

Further, there is known a printer which is provided with a door member in an outer covering wall thereof, in addition to the provision of a sheet cassette section in the interior of the outer casing. The door member is openably closed. When the door member is opened, the opened door member functions as a manual feeding tray. If a brightness difference between the recording sheets stacked on the manual feeding tray, and the sheet stacking surface of the manual feeding tray on which the recording sheets are stacked is significantly small, the user may find it difficult to recognize the recording sheets stacked on the manual feeding tray.

Further, generally, an auto document feeder is mounted on an image forming apparatus such as a facsimile machine or a copier. Accordingly, there is a demand for an improved arrangement, which makes it easy for a user to recognize that a document or documents has or have been discharged onto a document stacking surface of a document discharge tray at a glance, and aids the user to securely pick up the documents stacked on the document discharge tray.

Furthermore, for printers being formed with recesses at an appropriate position of the outer casing for the user to lift the printer by putting fingers of the user in the recesses, there is the demand of an arrangement which enables the user to readily perceive the recesses from the other parts of the outer casing.

### SUMMARY OF THE INVENTION

It is an object of the present invention to provide an image forming apparatus which enables a user to readily recognize a target on an outer casing of the image forming apparatus.

It is another object of the present invention to provide an image forming apparatus which enables a user to recognize that a recording sheet has been discharged on a sheet discharge tray or a document has been discharged on a document discharge tray at a glance, and facilitates the user to recognize that recording sheets are stacked on a sheet feeding tray at a glance.

It is another object of the invention to provide an image forming apparatus which can provide the improved operability that makes it easy for a user to recognize a specific portion of the image forming apparatus by distinguishing the specific portion of the image forming apparatus from the remaining portion thereof.

According to an aspect of the invention, an image forming apparatus comprises an image forming section for forming an image on a recording medium, and an outer casing for enclosing the image forming section. The outer casing is provided with a particular section at a specified portion of the outer casing to perform a particular function. The particular section bears a color which is darker than a general color of the outer casing.

These and other objects, features and advantages of the present invention will become more apparent upon reading of the following detailed description along with the accompanying drawings.

### BRIEF DESCRIPTION OF THE DRAWINGS

FIG. 1 is an external perspective view of a printer as a first embodiment of the invention.

FIG. 2 is an external perspective view of the printer shown in FIG. 1, illustrating that a manual feeding tray is opened.

FIG. 3 is an external perspective view of a modified printer in the first embodiment.

FIG. 4 is an external perspective view of a printer as a second embodiment of the invention, as viewed obliquely from above, with a front side of the printer facing forward on the left side.

FIG. 5 is an external perspective view of the printer shown in FIG. 4, as viewed obliquely from above, with the front side of the printer facing forward on the right side.

FIG. 6 is a schematic illustration of a copier incorporated with an image reader as a third embodiment of the invention.

FIG. 7 is an external perspective view of the copier of the third embodiment, as viewed obliquely from above.

FIG. 8 is a schematic sectional view of the printer of the first embodiment, showing an internal construction of the printer.

### DETAILED DESCRIPTION OF THE PREFERRED EMBODIMENTS

In the following, preferred embodiments of the invention are described referring to the accompanying drawings.

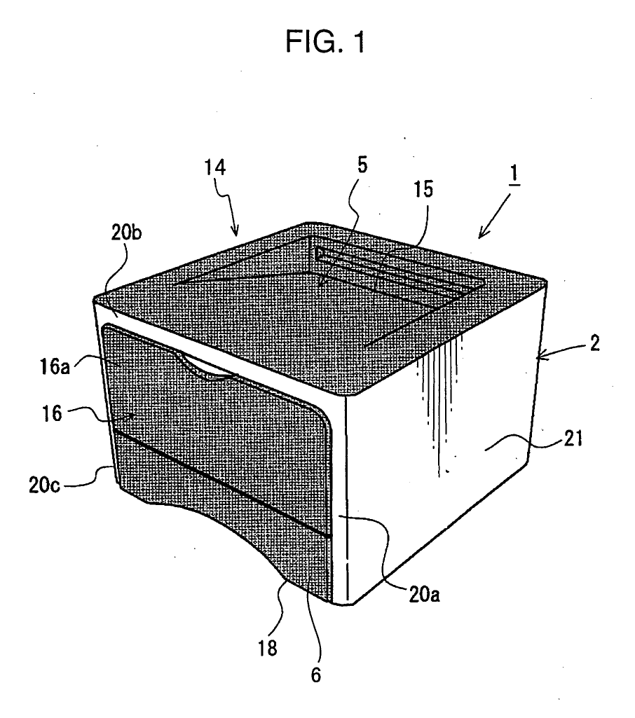

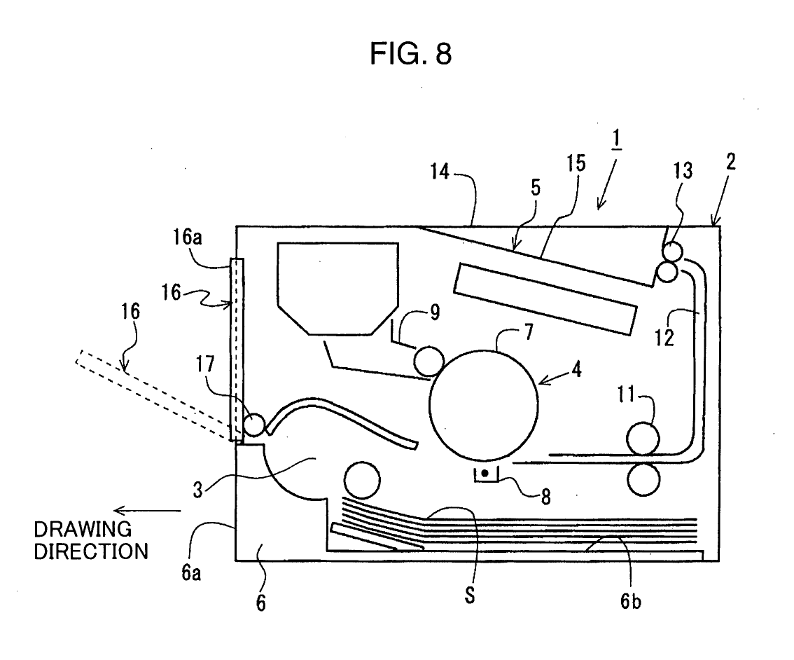

A printer 1 exemplifying an image forming apparatus as a first embodiment of the invention is described with reference to FIG. 1 showing an external perspective view of the printer 1 and FIG. 8 showing an internal construction of the printer 1. The printer 1 has an outer casing 2. A sheet storage section 3 and an image forming section 4 are arranged inside the outer casing 2. A sheet discharge tray 5 is formed on an upper part 14 of the outer casing 2. A sheet feeding tray 6 of the sheet storage section 3 is drawable from the outer casing 2. By drawing the sheet feeding tray 6 out of the sheet storage section 3, a user can stack sheet-like recording medium S (hereinafter, called as “recording sheet S”) of about one hundred to five hundreds in the sheet storage section 3.

As shown in FIG. 8, the image forming section 4 has a photosensitive drum 7, as well as a cleaning device (not shown), a charging device (not shown), a transfer device 8, and a developing device 9, which are arranged in the periphery of the photosensitive drum 7. A toner image is transferred onto a recording sheet S fed from the sheet feeding tray 6, and the recording sheet S carrying the transferred toner image is transported to a fixing device 11. When the recording sheet S is transported from the image forming section 4 to the fixing device 11, the transferred toner image is fixed to the recording sheet S by application of heat and a pressure. After the fixation by the fixing device 11, the recording sheet S is transported to a discharge roller 13 along a transport path 12, and is discharged onto a sheet stacking surface 15 of the sheet discharge tray 5, which is arranged on the upper portion 14 of the outer casing 2, by the discharge roller 13.

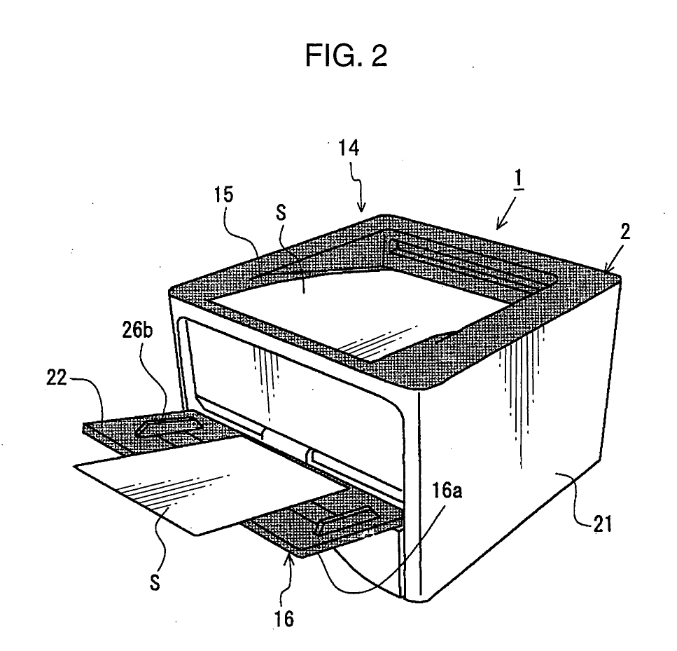

Further, a door member 16 is openably provided in the outer casing 2. Specifically, as shown in FIGS. 1 and 2, the door member 16 is formed on the same side as the drawing direction of the sheet feeding tray 6, and is openably and closably pivoted about an axis of a lower end of the door member 16, so that the door member 16 is opened and closed. In this arrangement, when the door member 16 is opened, the door member 16 is usable as a manual feeding tray. Recording sheets S stacked on the manual feeding tray 16 are fed into the image forming section 4 one by one by a feed roller 17.

In the printer 1 having the above construction, as shown in FIG. 1, the entirety of the upper portion 14 of the outer casing 2 including the sheet discharge tray 5, a side wall 6a of the sheet feeding tray 6, and an outer wall 16a of the manual feeding tray 16 are colored with a color having a brightness of 5 or less in Munsell value, so that a brightness difference in Munsell value is 3 or larger between these parts 14, 6a, and 16a, and the other parts of a front wall of the outer casing 2 such as peripheral end portions 20a, 20b, 20c except a bottom portion 18, and side walls 21 opposite to each other, which have a brightness of about 8 in Munsell value. Hereinafter, the brightness of the color is represented in terms of Munsell value (JIS Z 8721), unless otherwise specifically mentioned. The side wall 6a of the sheet feeding tray 6 and the outer wall 16a of the manual feeding tray 16 are movable parts of the outer casing 2. Further, the printer 1 satisfies the requirement that a brightness difference is 3 or larger between the parts of the outer casing 2 having the brightness 5 or less, and the recording sheet S, e.g., a commercially available general copy sheet.

In this arrangement, a user located remotely away from the printer 1 can clearly recognize, at a glance, that a recording sheet S is discharged onto the sheet discharge tray 5 by the brightness difference between the recording sheet S discharged on the sheet discharge tray 5, and the sheet stacking surface 15 of the sheet discharge tray 5.

Further, since the outer surfaces of the movable parts such as the side wall 6a of the sheet feeding tray 6 and the outer wall 16a of the manual feeding tray 16 are colored with the color substantially identical to the color of the sheet discharge tray 5, it is possible to discriminate the movable pars of the outer casing 2 from the fixed parts of the outer casing 2. This arrangement improves the user's operability on the sheet discharge tray 5 and the manual feeding tray 16.

Further, according to the above arrangement, since the specific parts of the outer casing 2 are colored with the color having the brightness of 5 or less, the parts of the outer casing 2 other than the above specific parts can be colored with a bright color in harmony with the colors of the office equipment in the office or the color of the desk near the printer 1. Thereby, the printer 1, when installed in the office, looks in harmony with the office environment.

In this embodiment, as shown in FIG. 2, by coloring an inner wall, namely, a sheet stacking surface 22 of the manual feeding tray 16 on the back of the outer wall 16a with a color of a brightness of 5 or less, the user located away from the printer 1 can clearly recognize at a glance that the recording sheets S stacked on the manual feeding tray 16 have been dispensed, and timely replenish recording sheets S. This arrangement contributes to improvement of the user's operability of the printer 1.

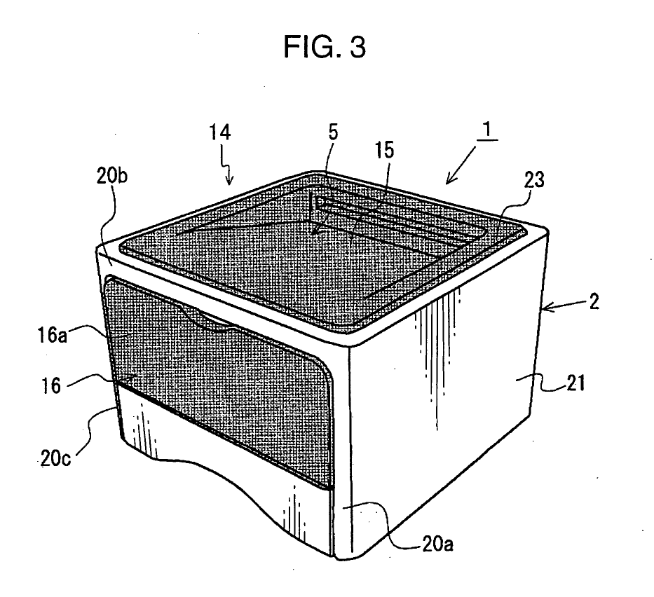

Alternatively, as shown in FIG. 3, it is possible to color the outer wall 16a and the inner wall 22 (see FIG. 2) of the manual feeding tray 16, the sheet discharge tray 5 of the upper portion 14 of the outer casing 2, and a peripheral portion surrounding the sheet discharge tray 5, namely, a perimeter portion 23 except an outermost frame-like portion with a color having a brightness of 5 or less.

Alternatively, it is possible to color a sheet stacking surface 6b of the sheet feeding tray 6 with a color of a brightness of 5 or less, so that the sheet stacking surface 6b looks darker than other parts of the outer casing 2 surrounding the sheet feeding tray 6 or a general color of the printer 1.

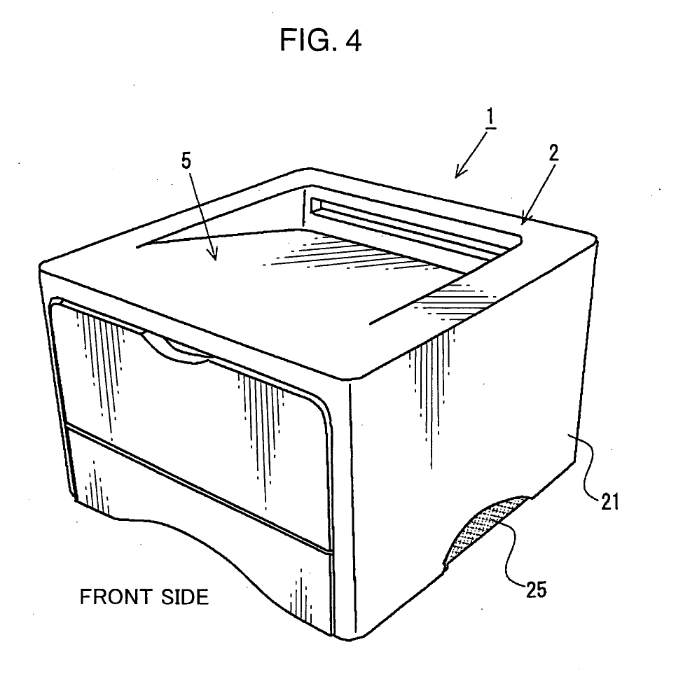

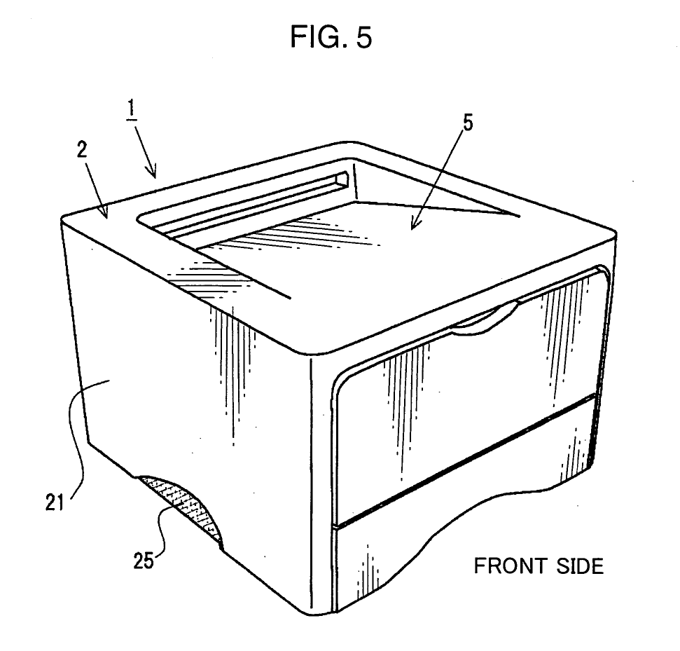

FIGS. 4 and 5 are external perspective views each showing a printer 1 exemplifying an image forming apparatus as a second embodiment of the invention. As shown in FIGS. 4 and 5, a finger recess or recess portion 25 is formed in a lower part of each of side walls 21, 21 of the printer 1, so that a user can easily lift the printer 1 by engaging the fingers of the user in the recess portions 25, 25.

The outer surface of each recess portion 25 is colored with a color having a brightness of 5 or less, so that a brightness difference is 3 or larger between the outer surfaces of the recess portions 25, and other parts of an outer casing 2 other than the recess portions 25 or a general color of the printer 1. The other parts of the outer casing 2 are generally colored with a color having a brightness of about 8, for instance.

In this way, the printer 1 as the second embodiment has a feature that the recess portion 25 as an example of a specific portion of the image forming apparatus has a darker color than other parts of the outer casing 2 surrounding the recess portion 25 or a general color of the printer 1. Thereby, the user can easily find the recess portions 25.

It is possible to apply the arrangement of the second embodiment to the first embodiment.

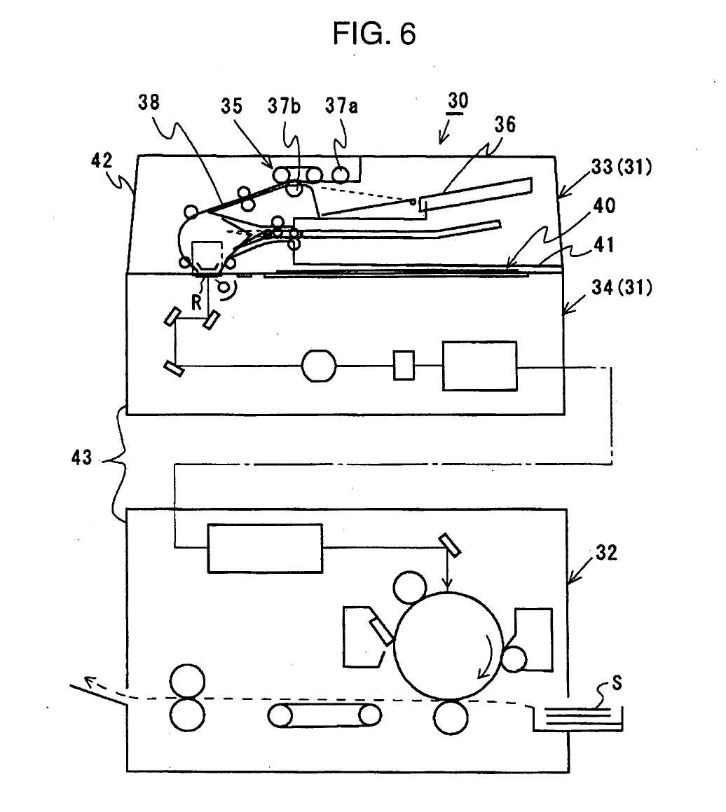

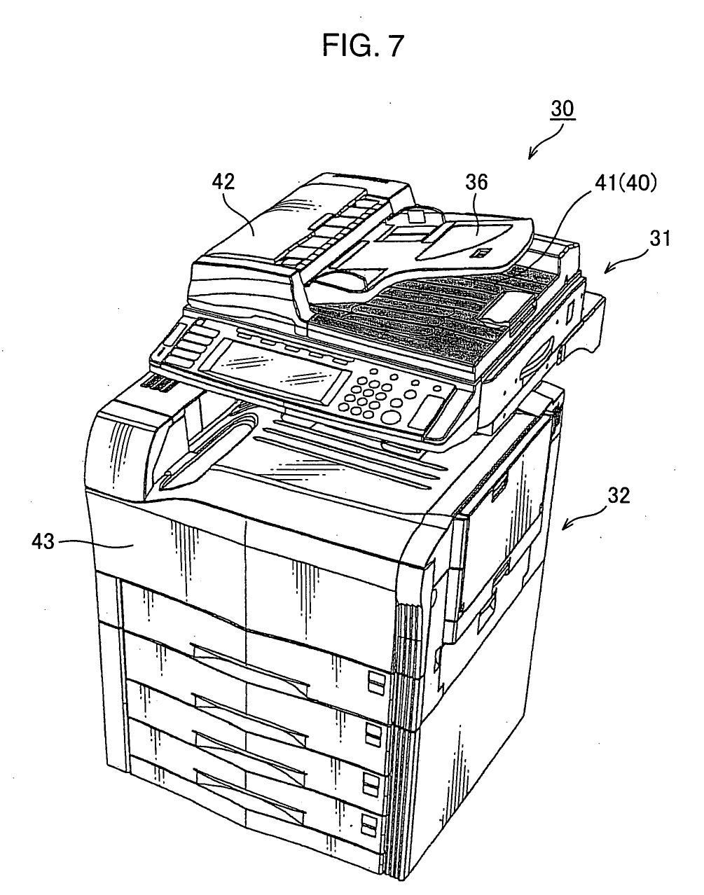

FIGS. 6 and 7 show a third embodiment of the invention. Specifically, FIG. 6 shows a copier 30 as an example of the inventive image forming apparatus, as well as an image reader 31 incorporated in the copier 30.

As shown in FIG. 6, the copier 30 has an image forming section 32 for forming an image on a recording sheet S based on image data read by the image reader 31 or image data sent from an external apparatus such as a personal computer, an information terminal apparatus, a facsimile machine or a like apparatus. The image reader 31 of the copier 30 includes an automatic document feeding section 33, and a scanner section 34 serving as an image reading section for optically reading the image of a document (not shown) transported by the automatic document feeding section 33 at a specified image reading position R for photoelectric conversion of the image data.

The automatic document feeding section 33 is constructed such that a document placed on a document feeding table 36 of a document feeding section 35 is transported to the specified image reading position R along a document transport path 38 by various transport rollers such as rollers 37a and 37b, followed by discharge of the document onto a document discharge tray 40 located underneath the document feeding table 36.

In the above arrangement, as shown in FIG. 7, a document stacking surface 41 of the document discharge tray 40 is colored with a dark color, as compared with a general color of the apparatus or the other parts of the automatic document feeding section 33 such as an outer casing 42 of the automatic document feeding section 33, or an outer surface of an outer casing 43 of the copier 30. For instance, the outer surface of the outer casing 43 of the copier 30 is colored with a color of a brightness of about 8, which is a relatively bright color. In other words, the document stacking surface 41 of the document discharge tray 40 is colored with a color of a brightness of 5 or less, so that a brightness difference is 3 or larger between the document stacking surface 41 and the outer surfaces of the outer casings 42 and 43.

According to the above embodiment, as far as the document to be discharged on the document stacking surface 41 of the document discharge tray 40 has a general white color or a brightness of about 8, a brightness difference between the document discharged on the document discharge tray 40, and the document stacking surface 41 is as large as 3 or more, which makes it easier for the user to recognize the document discharged on the document discharge tray 40 at a glance. As a result, this arrangement enables the user to securely pick up the document discharged on the document discharge tray 40.

In the foregoing, the present invention has been described by taking the preferred examples of the printer embodying the inventive image forming apparatus. Alternatively, the invention is applicable to a copier, a facsimile machine, a complex machine capable of functioning a copier and a facsimile machine, a document reader of a scanner, or a like apparatus. Also, the inventive image forming apparatus embraces an apparatus of an ink jet type, as well as an apparatus of an electrophotographic type.

As described above, an image forming apparatus is provided with an image forming section which forms an image on a recording medium, and an outer casing which encloses the image forming section, and a particular section which is provided at a specified portion of the outer casing and performs a particular function. The particular section has a color darker than a general color of the outer casing.

With this construction, the user can easily recognize a change over the particular section owing to the brightness difference. In the case where the general color of the outer casing of the image forming apparatus is near the color of a recording medium or a document, also, this makes it easy for the user to recognize a change which is caused by the recording medium or document in the particular section. This arrangement contributes to improvement on the user's operability of the image forming apparatus.

The particular section may be preferably made to have a brightness of 5 or less in Munsell value. Further, it may be preferable that the color of the particular section has a brightness difference of 3 or larger in Munsell value against the general color of the outer casing.

Such brightness difference can be harmonizable with the general color of the office while enabling the operator to readily recognize a target.

The particular section may be a stacking surface of a discharge tray on which a recording medium bearing a formed image is placed.

With this arrangement, the user can easily recognize the recording medium discharged on the discharge tray by the brightness difference between the recording medium and the discharge tray that is caused by coloring the stacking surface of the discharge tray with the darker color than the color of the outer casing in the periphery of the discharge tray.

Also, the particular section may be a stacking surface of a feeding tray on which a recording medium is placed.

With this arrangement, the user can easily recognize the recording medium on the feeding tray by the brightness difference between the recording medium and the feeding tray that is caused by coloring the stacking surface of the feeding tray with the darker color than the color of the outer casing in the periphery of the feeding tray.

Further, the particular section may be a stacking surface of a door member which is openably provided on the outer casing. The door member may include a manual feeding tray.

With this arrangement, the user can easily recognize the recording medium on the manual feeding tray by the brightness difference between the recording medium and the manual feeding tray that is caused by coloring the surface of the manual feeding tray with the darker color than the color of the outer casing in the periphery of the feeding tray.

Moreover, the particular section may be a recess which accepts a finger of an operator.

With this arrangement, the user can easily recognize the finger recess by the brightness difference between the finger recess and the outer casing that is caused by coloring the finger recess with the darker color than the color of the outer casing in the periphery of the finger recess.

The image forming apparatus may be further provided with a document feeder for feeding a document, an image reader for reading the document fed from the document feeder, and a document discharge tray for stacking the document discharged from the image reader. A stacking surface of the document discharge tray may be preferably made to have a color darker than a general color of the outer casing.

With this arrangement, the user can easily recognize the document discharged onto the document discharge tray by the brightness difference between the document and the document discharge tray that is caused by coloring the document stacking surface of the document discharge tray with the darker color than the color of the outer casing in the periphery of the document discharge tray. This arrangement is effective in aiding the user to pick up the document discharged from the document discharge tray without fail.

This application is based on Japanese Patent Application No. 2004-199031 filed on Jul. 6, 2004, the contents of which are hereby incorporated by reference.

Although the present invention has been fully described by way of example with reference to the accompanying drawings, it is to be understood that various changes and modifications will be apparent to those skilled in the art. Therefore, unless otherwise such changes and modifications depart from the scope of the present invention hereinafter defined, they should be construed as being included therein.

What is claimed is:

1. An image forming apparatus comprising:
an image forming section which forms an image on a recording medium;
an outer casing which encloses the image forming section; and
a particular section which is provided at a specified portion of the outer casing and performs a particular function, the particular section having a color darker than a general color of the outer casing.

2. The image forming apparatus according to claim 1, wherein the particular section has a brightness of 5 or less in Munsell value.

3. The image forming apparatus according to claim 2, wherein the color of the particular section has a brightness difference of 3 or larger in Munsell value against the general color of the outer casing.

4. The image forming apparatus according to claim 1, wherein the color of the particular section has a brightness difference of 3 or larger in Munsell value against the general color of the outer casing.

5. The image forming apparatus according to claim 1, wherein the particular section is a stacking surface of a discharge tray on which a recording medium formed with an image is placed.

6. The image forming apparatus according to claim 1, wherein the particular section is a stacking surface of a feeding tray on which a recording medium is placed.

7. The image forming apparatus according to claim 1, wherein the particular section is a stacking surface of a door member which is openably provided on the outer casing.

8. The image forming apparatus according to claim 7, wherein the door member includes a manual feeding tray.

9. The image forming apparatus according to claim 1, wherein the particular section is a recess which accepts a finger of an operator.

10. The image forming apparatus according to claim 1, further comprising a document feeder for feeding a document, an image reader for reading the document fed from the document feeder, and a document discharge tray for stacking the document discharged from the image reader, wherein the particular section is a stacking surface of the document discharge tray.
